(19) United States
(12) Patent Application Publication
(10) Pub. No.: US 2024/0008052 A1
(43) Pub. Date: Jan. 4, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/250,632

(22) PCT Filed: Nov. 2, 2021
(86) PCT No.: PCT/JP2021/040325

§ 371 Date: Apr. 26, 2023

(30) Foreign Application Priority Data
Nov. 6, 2020 (JP) 2020-186141

(51) Int. Cl. H04W 72/231; H04L 43/0805

(52) U.S. Cl. CPC H04W 72/231; H04L 43/0805

(57) ABSTRACT

A terminal according to one aspect of the present disclosure includes a receiving section that receives a medium access control-control element (MAC CE) to activate two transmission configuration indication (TCI) states for one codepoint of a field in downlink control information, and a control section that determines one or more reference signals in a case where a reference signal for beam failure detection (BFD) is not configured, the one or more reference signals being used for BFD. According to one aspect of the present disclosure, it is possible to appropriately determine a BFD RS.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For NR, a user terminal (User Equipment (UE)) that performs procedure for switching to another beam in response to detection of beam failure (BF) (which may be referred to as beam failure recovery (BFR) procedure, BFR, and so on) is under study.

However, a method of determining a BFD reference signal (RS) is indefinite. Unless the BFD RS is appropriately determined, throughput reduction or communication quality degradation may occur.

Thus, an object of the present disclosure is to provide a terminal, a radio communication method, and a base station that detect beam failure appropriately.

### Solution to Problem

A terminal according to one aspect of the present disclosure includes a receiving section that receives a medium access control-control element (MAC CE) to activate two transmission configuration indication (TCI) states for one codepoint of a field in downlink control information, and a control section that determines one or more reference signals in a case where a reference signal for beam failure detection (BFD) is not configured, the one or more reference signals being used for BFD.

### Advantageous Effects of Invention

According to one aspect of the present disclosure, it is possible to appropriately determine a BFD RS.

### BRIEF DESCRIPTION OF DRAWINGS

FIG. 1 is a diagram to show an example of beam recovery procedure.

FIG. 2 is a diagram to show an example of option 1 in a second embodiment.

FIG. 3 is a diagram to show an example of option 2 in the second embodiment.

FIG. 4 is a diagram to show an example of option 3 in the second embodiment.

FIG. 5 is a diagram to show an example of a third embodiment.

FIG. 6 is a diagram to show an example of an RLM-RS determination rule according to RS determination method 1.

FIG. 7 is a diagram to show an example of an RLM-RS determination rule according to RS determination method 2.

FIG. 8 is a diagram to show an example of an RLM-RS determination rule according to RS determination method 3.

FIG. 9 is a diagram to show an example of a BFD-RS determination rule according to RS determination method 4.

FIG. 10 is a diagram to show an example of a BFD-RS determination rule according to RS determination method 5.

FIG. 11 is a diagram to show an example of a BFD-RS determination rule according to RS determination method 6.

FIG. 12 is a diagram to show an example of a schematic structure of a radio communication system according to one embodiment.

FIG. 13 is a diagram to show an example of a structure of a base station according to one embodiment.

FIG. 14 is a diagram to show an example of a structure of a user terminal according to one embodiment.

FIG. 15 is a diagram to show an example of a hardware structure of the base station and the user terminal according to one embodiment.

### DESCRIPTION OF EMBODIMENTS

### (TCI, Spatial Relation, QCL)

For NR, control of reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, and so on. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS being in a relationship of QCL type X with a (DMRS for) certain channel/signal, and this RS may be referred to as a QCL source of QCL type X in the TCI state.

For the PDCCH and the PDSCH, a QCL type A RS may always be configured, and a QCL type D RS may be additionally configured. It is difficult to estimate doppler shift, delay, and the like by using one-shot reception of a DMRS, and thus the QCL type A RS is used for improvement of channel estimation accuracy. The QCL type D RS is used for receive beam determination in DMRS reception.

For example, TRS 1-1, TRS 1-2, TRS 1-3, and TRS 1-4 are transmitted, and TRS 1-1 is notified as a QCL type C/D RS by a TCI state for the PDSCH. The TCI state is notified, thereby allowing the UE to use, for reception/channel estimation for a DMRS for the PDSCH, information obtained from a result of past periodic reception/measurement of TRS 1-1. In this case, a QCL source of the PDSCH is TRS 1-1, and a QCL target is the DMRS for the PDSCH.

### (Multi-TRP)

For NR, one or a plurality of transmission/reception points (TRPs) (multiple TRPs (multi-TRP (MTRP))) that perform DL transmission to the UE by using one or a plurality of panels (multiple panels) are under study. The UE that performs UL transmission to the one or the plurality of TRPs by using one or a plurality of panels is also under study.

Note that the plurality of TRPs may correspond to the same cell identifier (ID), or may correspond to different cell IDs. The cell ID may be a physical cell ID, or may be a virtual cell ID.

The multiple TRPs (for example, TRP #1 and TRP #2) may be connected to each other by an ideal/non-ideal backhaul, and information, data, and the like may be exchanged. From respective TRPs of the multiple TRPs, different code words (CWs) and different layers may be transmitted. As a mode of multi-TRP transmission, non-coherent joint transmission (NCJT) may be used.

In NCJT, for example, TRP #1 performs modulation mapping on a first code word to transmit a first number of layers (for example, 2 layers) by performing layer mapping and to transmit a first PDSCH by using first precoding. TRP #2 performs modulation mapping on a second code word to transmit a second number of layers (for example, 2 layers) by performing layer mapping and to transmit a second PDSCH by using second precoding.

Note that a plurality of PDSCHs (multiple PDSCHs) on which NCJT is performed may be defined as partially or fully overlapping with respect to at least one of time and frequency domains. In other words, a first PDSCH from a first TRP and a second PDSCH from a second TRP may overlap with each other in at least one of time and frequency resources.

It may be assumed that these first PDSCH and second PDSCH are not in a quasi-co-location (QCL) relationship (not quasi-co-located). Reception of the multiple PDSCHs may be interpreted as simultaneous reception of PDSCHs other than a certain QCL type (for example, QCL type D).

A plurality of PDSCHs (which may be referred to as multiple PDSCHs) from multiple TRPs may be scheduled with use of one piece of DCI (single DCI, single PDCCH) (single master mode, multiple TRPs based on single DCI (single-DCI based multi-TRP)). A respective plurality of PDSCHs from multiple TRPs may be scheduled with use of a plurality of pieces of DCI (multiple DCI, multiple PDSCHs) (multi-master mode, multiple TRPs based on multiple DCI (multi-DCI based multi-TRP)).

For URLLC for multiple TRPs, support for repetition of PDSCHs (transport blocks (TBs) or code words (CWs)) crossing the multiple TRPs is under study. Support for repetition schemes (URLLC schemes, for example, schemes 1, 2a, 2b, 3, and 4) crossing the multiple TRPs on a frequency domain, a layer (spatial) domain, or a time domain is under study. Scheme 1 applies space division multiplexing (SDM) to multiple PDSCHs from the multiple TRPs. Schemes 2a and 2b apply frequency division multiplexing (FDM) to PDSCHs from the multiple TRPs. In scheme 2a, redundancy versions (RVs) for the multiple TRPs are the same. In scheme 2b, the RVs for the multiple TRPs may be the same, or may be different from each other. Schemes 3 and 4 apply time division multiplexing (TDM) to multiple PDSCHs from the multiple TRPs. In scheme 3, the multiple PDSCHs from the multiple TRPs are transmitted in one slot. In scheme 4, the multiple PDSCHs from the multiple TRPs are transmitted in different slots.

According to such a multi-TRP scenario, more flexible transmission control using a channel with satisfactory quality is possible.

In order to support intra-cell (having the same cell ID) and inter-cell (having different cell IDs) multi-TRP transmission based on multiple PDSCHs, in RRC configuration information for linking a plurality of pairs of PDSCHs and PDSCHs having multiple TRPs, one control resource set (CORESET) in PDCCH configuration information (PDCCH-Config) may correspond to one TRP.

The UE may judge that the multiple TRPs are multiple TRPs based on multiple DCI when at least one of the following condition 1 and condition 2 is satisfied. In this case, the TRPs may be interpreted as CORESET pool indices.

### {Condition 1}

One CORESET pool index is configured.

### {Condition 2}

Two different values (for example, 0 and 1) of CORESET pool indices are configured.

The UE may judge that the multiple TRPs are multiple TRPs based on single DCI when the following condition is satisfied. In this case, two TRPs may be interpreted as two TCI states specified by a MAC CE/DCI.

### {Condition}

In order to indicate one or two TCI states for one codepoint of a TCI field in DCI, a “MAC CE for enhanced TCI state activation/deactivation for a UE-specific PDSCH (Enhanced TCI states Activation/Deactivation for UE-specific PDSCH MAC CE)” is used.

DCI for common beam indication may be a UE-specific DCI format (for example, DL DCI format (for example, 1_1 or 1_2) or UL DCI format (for example, 0_1 or 0_2)), or may be a UE-group common DCI format.

### (Unified/Common TCI Framework)

According to a unified TCI framework, UL and DL channels can be controlled by a common framework. Instead of defining a TCI state or a spatial relation for each channel just as Rel. 15 does, the unified TCI framework may indicate a common beam and apply the common beam to all UL and DL channels, or may apply a UL common beam to all UL channels and apply a DL common beam to all DL channels.

One common beam for both DL and UL or a DL common beam and a UL common beam (two common beams in total) are under study.

The UE may assume the same TCI state (joint TCI state, joint TCI state pool, joint common TCI state pool) for the UL and DL.

RRC may configure a plurality of TCI states (joint common TCI state pools) for both DL and UL. Each of the plurality of TCI states may be a QCL type A/D RS. As the QCL type A/D RS, an SSB, a CSI-RS, or an SRS may be configured. The MAC CE may activate some of the plurality of configured TCI states. The DCI may indicate at least one of the plurality of activated TCI states.

Default beams for the UL and DL may be set to the same by MAC CE-based beam management (MAC CE level beam indication). A default TCI state for the PDSCH is updated to set the default beams to be a default UL beam (spatial relation).

A common beam/unified TCI state from the same TCI state pool for both UL and DL (joint common TCI state pool) may be indicated by beam management based on the DCI (DCI level beam indication). M (>1) TCI states may be activated by the MAC CE. UL/DL DCI may select one TCI state from M active TCI states. The selected TCI state may be applied to channels/RSs for both UL and DL.

The UE may assume different TCI states (separate TCI states, separate TCI state pools, UL separate TCI state pool and DL separate TCI state pool, separate common TCI state pools, UL common TCI state pool and DL common TCI state pool) for respective UL and DL.

The RRC (parameter, information element) may configure a plurality of TCI states (pools) for each of UL and DL channels.

The MAC CE may select (activate) one or more (for example, a plurality of) TCI states (sets) for each of the UL and DL channels. The MAC CE may activate two sets of TCI states.

The DL DCI may select (indicate) one or more (for example, one) TCI states. This TCI state may be applied to one or more DL channels. The DL channel may be a PDCCH/PDSCH/CSI-RS. The UE may determine a TCI state for each DL channel/RS by using a TCI state operation (TCI framework) of Rel. 16.

The UL DCI may select (indicate) one or more (for example, one) TCI states. This TCI state may be applied to one or more UL channels. The UL channel may be a PUSCH/SRS/PUCCH.

As use cases of the separate common TCI state pool, the following use case 0, use case 1, and use case 2 are under study.

### {Use Case 0}

The UE uses different UL beams due to maximum permitted exposure (MPE).

UL of panel #1 has an MPE issue, and the UE uses panel #2 for the UL.

### {Use Case 1}

The UE uses different UL beams due to UL signal strength.

A distance between the UE and TRP (cell, base station)#1 is longer than a distance between the UE and TRP #2. Here, L1-RSRP of panel #1 is higher than L1-RSRP of panel #2, and UL transmit power of panel #2 is higher than UL transmit power of panel #1. The UE uses panel #1 for DL from TRP #1, and uses panel #2 for UL to TRP #2.

### {Use Case 2}

The UE uses different UL beams due to UL load balancing.

L1-RSRP of panel #1 is higher than L1-RSRP of panel #2, and a UL load of panel #2 is lower than a UL load of panel #1. The UE uses panel #1 for DL from TRP #1, and uses panel #2 for UL to TRP #2.

It is conceivable that far more scenarios having different requirements are studied. For example, in multi-TRP transmission, high speed train (HST) transmission, inter-cell mobility in a period in which there is a possibility that the UE is connected to two cells, and the like, common beams for respective TRPs and cells may be different from each other.

In this case, the UE may have multiple panels for FR 2. In this case, common beams for respective UE panels may be different from each other.

In the unified TCI framework, the UE may support a joint TCI based on a DL TCI framework of Rel. 15/16. The TCI may include a TCI state including at least one source RS to provide reference (UE assumption) for determination of at least one of QCL and a spatial filter.

A case that the UE uses a joint TCI (joint TCI pool) including reference for both a DL beam and a UL beam and a case that the UE uses one separate TCI (pool) for DL and one separate TCI (pool) for UL are under study.

For the separate TCI pool, a case that a UL TCI state is obtained from the same pool as that for a DL TCI state and a case that the UL TCI state is obtained from a pool different from that for the DL TCI state are under study.

In the separate TCI pool, an active TCI pool for each of UL and DL may be configured/activated by RRC/MAC CE. An active TCI pool common to the UL and DL may be configured/activated by the RRC/MAC CE.

For DCI indication of a common beam (common TCI state), a TCI field in the DL DCI may be reused, or a new field (for example, a unified TCI field) in the DL DCI may be used. The DL DCI, PDSCH scheduling DCI, DCI format 1_1, and DCI format 1_2 may be interchangeably interpreted.

For the DCI indication of the common beam (common TCI state), a new field (for example, a unified TCI field) in the UL DCI may be used. The UL DCI, PUSCH scheduling DCI, DCI format 0_1, and DCI format 0_2 may be interchangeably interpreted.

Feedback on the DCI indication of the common beam (common TCI state) is under study. If reception of the DCI indication of the common beam has failed, the base station misrecognizes the common beam. Thus, a case that a timing of updating the common beam is a timing after the UE transmits the feedback on the DCI indication is under study. For example, when the DL DCI indicates the common beam (TCI #2), the common beam is updated (to TCI #2) after the UE transmits ACK/NACK (HARQ-ACK information) on a PUCCH/PUSCH. For example, when the UL DCI indicates the common beam (TCI #2), the common beam is updated (to TCI #2) after the UE transmits a PUSCH.

### (RLM)

Incidentally, also in NR, radio link monitoring (RLM) is used.

In NR, the base station may configure, for the UE, a radio link monitoring reference signal (Radio Link Monitoring RS (RLM-RS)) for each BWP by using higher layer signaling. The UE may receive configuration information for RLM (for example, a “RadioLinkMonitoringConfig” information element of RRC).

The configuration information for RLM may include resource configuration information for failure detection (for example, a higher layer parameter “failureDetectionResourcesToAddModList”). The resource configuration information for failure detection may include a parameter related to the RLM-RS (for example, a higher layer parameter “RadioLinkMonitoringRS”).

The parameter related to the RLM-RS may include information indicating that the parameter corresponds to the purpose of RLM, an index corresponding to resources of the RLM-RS (for example, an index included in a higher layer parameter “failureDetectionResources”), and the like. For example, the index may be a CSI-RS resource configuration index (for example, a non-zero power CSI-RS resource ID), or may be an SS/PBCH block index (SSB index).

The UE may identify an RLM-RS resource on the basis of the index corresponding to resources of the RLM-RS, and may perform RLM by using the RLM-RS resource.

When RadioLinkMonitoringRS (RLM-RS) is not provided for the UE, and a TCI state including one or more CSI-RSs for PDCCH reception is provided for the UE:
When an active TCI state for the PDCCH reception includes only one RS, the UE may use, for RLM, an RS provided for a TCI state for the active TCI state for the PDCCH reception.
When the active TCI state for the PDCCH reception includes two RSs, the UE expects that one RS has QCL type D, the UE uses the RS having QCL type D for RLM, and the UE does not expect that both of the RSs have QCL type D.
The UE may not be required to use an aperiodic or semi-persistent RS for RLM.
For Lₘₐₓ (maximum number of SS/PBCH block candidates for each half-frame)=4, the UE may select, in sequence starting from the shortest monitoring periodicity of a search space set, N_{RLM} RSs provided for an active TCI state for PDCCH reception in a CORESET associated with the search space set. When more than one CORESET is associated with search space sets having the same monitoring periodicity, the UE may determine a CORESET sequence starting from the highest CORESET index (ID). The UE may select N_{RLM} RSs in accordance with this CORESET sequence.

When RadioLinkMonitoringRS is not provided for the UE, the UE may not expect that more than N_{RLM} RadioLinkMonitoringRSs are used for RLM.

When Lₘₐₓ=4, N_{RLM} may be equal to 2 (N_{RLM}=2). When Lₘₐₓ=8, N_{RLM} may be equal to 4 (N_{RLM}=4). When Lₘₐₓ=64, N_{RLM} may be equal to 8 (N_{RLM}=8).

When information about a reference signal (RS) for RLM (for example, RadiolinkMonitoringRS) is not provided for the UE, the UE determines the RLM-RS on the basis of a TCI state for a PDCCH. The number of RLM-RSs should be equal to or less than N_{RLM}.

In a case where the information about the RLM RS is not provided for the UE (in a case where the information about the RLM RS is not explicitly notified to the UE), with respect to how the UE determines the RLM-RS, the following issue 1 and issue 2 are conceivable.

### <Issue 1>

NR Rel. 15 just defines an RLM-RS determination (filtering) rule (UE operation) for a case of Lₘₐₓ being 4 in a case where N_{RLM} is 2 and a maximum number of CORESETs is 3. In Rel. 16, RLM-RS determination rules for a case where Lₘₐₓ=4 and N_{RLM}=2 and a case where Lₘₐₓ=8 and N_{RLM}=4, while a maximum number of CORESETs is 5 are indefinite.

### <Issue 2>

In NR Rel. 15, the UE determines a CORESET having a TCI state used for the RLM-RS on the basis of the following two factors.
Monitoring periodicity of search space associated with CORESET (in order starting from shortest monitoring periodicity)
CORESET ID (in order starting from highest CORESET ID in case where more than one CORESET corresponding to same monitoring periodicity is present)

### (Beam Failure Recovery)

For NR, communication using beam forming is under study. For example, a UE and a base station (for example, gNodeB (gNB)) may use a beam used for signal transmission (also referred to as a transmit beam, Tx beam, and so on) and a beam used for signal reception (also referred to as a receive beam, Rx beam, and so on).

Using the beam forming causes vulnerability to interference from an obstruction, and thus it is assumed that radio link quality deteriorates. Due to deterioration of the radio link quality, radio link failure (RLF) may occur frequently. Occurrence of RLF requires a reconnected cell, and thus frequent occurrence of RLF causes deterioration of system throughput.

For NR, in order to suppress occurrence of RLF, implementation of procedure for switching to another beam (which may be referred to as beam recovery (BR), beam failure recovery (BFR), L1/L2 (Layer 1/Layer 2) beam recovery, and so on) in a case where quality of a specific beam deteriorates is under study. Note that the BFR procedure may be simply referred to as BFR.

Note that beam failure (BF) of the present disclosure may be referred to as link failure or radio link failure (RLF).

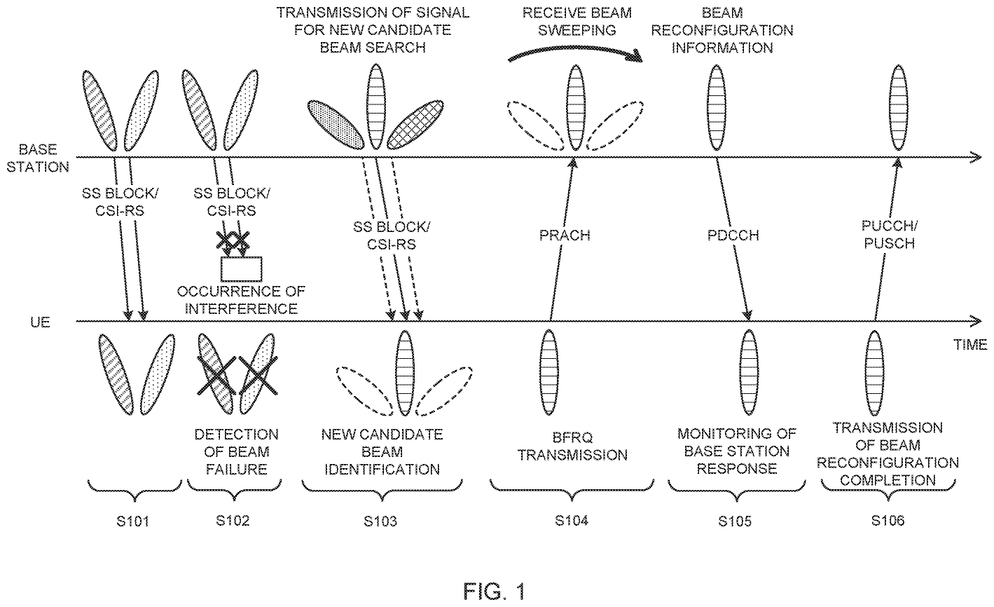

FIG. 1 is a diagram to show an example of the beam recovery procedure in Rel. 15 NR. The number of beams and the like are just examples, and are not limited to this. In an initial state (step S101) of FIG. 1, the UE performs measurement based on a reference signal (RS) resource transmitted with use of two beams.

The RS may be at least one of a synchronization signal block (SSB) and an RS for channel state measurement (Channel State Information RS (CSI-RS)). Note that the SSB may be referred to as an SS/PBCH (Physical Broadcast Channel) block and so on.

The RS may be at least one of a primary synchronization signal (Primary SS (PSS)), a secondary synchronization signal (Secondary SS (SSS)), a mobility reference signal (Mobility RS (MRS)), a signal included in the SSB, the SSB, the CSI-RS, a demodulation reference signal (DMRS), a beam-specific signal, and the like, or may be a signal constituted by expanding, changing, and the like these signals. The RS measured at step S101 may be referred to as an RS for beam failure detection (Beam Failure Detection RS (BFD-RS)) and so on.

At step S102, due to interference of a radio wave from the base station, the UE fails to detect the BFD-RS (or quality of reception of the RS deteriorates). Such interference may occur due to, for example, influence of an obstruction, phasing, interference, and the like between the UE and the base station.

The UE detects beam failure when a certain condition is satisfied. For example, the UE may detect occurrence of the beam failure when a block error rate (BLER) with respect to all of configured BFD-RSs (BFD-RS resource configurations) is less than a threshold value. When occurrence of the beam failure is detected, a lower layer (physical (PHY) layer) of the UE may notify (indicate) a beam failure instance for a higher layer (MAC layer).

Note that judgment standards (criteria) are not limited to the BLER, and may be reference signal received power in the physical layer (Layer 1 Reference Signal Received Power (L1-RSRP)). In place of the RS measurement or in addition to the RS measurement, beam failure detection may be performed on the basis of a downlink control channel (Physical Downlink Control Channel (PDCCH)) and the like. The BFD-RS may be expected to be quasi-co-location (QCL) with a DMRS for a PDCCH monitored by the UE.

Here, QCL is an indicator indicating statistical properties of the channel. For example, when a certain signal/channel and another signal/channel are in a relationship of QCL, it may be indicated that it is assumable that at least one of doppler shift, a doppler spread, an average delay, a delay spread, and a spatial parameter (for example, a spatial reception filter/parameter (Spatial Rx Filter/Parameter) or a spatial transmission filter/parameter (Spatial Tx (transmission) Filter/Parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as spatial QCL (sQCL).

Information related to the BFD-RS (for example, indices, resources, numbers, the number of ports, precoding, and the like for the RS), information related to the beam failure detection (BFD) (for example, the above-mentioned threshold value), and the like may be configured (notified) for the UE with use of higher layer signaling or the like. The information related to the BFD-RS may be referred to as information related to resources for BFR and so on.

The MAC layer of the UE may start a certain timer (which may be referred to as a beam failure detection timer) when receiving beam failure instance notification from the PHY layer of the UE. The MAC layer of the UE may trigger BFR (for example, start any one of random access procedures mentioned later) when receiving the beam failure instance notification certain times (for example, beamFailureInstanceMaxCount configured by RRC) or more until the timer expires.

When there is no notification from the UE (for example, time without notification exceeds certain time) or when receiving a certain signal (beam recovery request at step S104) from the UE, the base station may judge that the UE has detected beam failure.

At step S103, for beam recovery, the UE starts a search for a new candidate beam for use in new communication. The UE may select, by measuring a certain RS, the new candidate beam corresponding to the RS. The RS measured at step S103 may be referred to as an RS for new candidate beam identification (New Candidate Beam Identification RS (NCBI-RS)), a CBI-RS, a Candidate Beam RS (CB-RS), and so on. The NCBI-RS may be the same as the BFD-RS, or may be different from the BFD-RS. Note that the new candidate beam may be referred to as a new candidate beam, a candidate beam, or a new beam.

The UE may determine a beam corresponding to an RS satisfying a certain condition as the new candidate beam. For example, the UE may determine the new candidate beam on the basis of an RS with L1-RSRP exceeding a threshold value out of configured NCBI-RSs. Note that judgment standards (criteria) are not limited to the L1-RSRP. The UE may determine the new candidate beam by using at least one of L1-RSRP, L1-RSRQ, and L1-SINR (signal to interference plus noise power ratio). The L1-RSRP related to an SSB may be referred to as SS-RSRP. The L1-RSRP related to a CSI-RS may be referred to as CSI-RSRP. Similarly, the L1-RSRQ related to an SSB may be referred to as SS-RSRQ. The L1-RSRQ related to a CSI-RS may be referred to as CSI-RSRQ. Similarly, the L1-SINR related to an SSB may be referred to as SS-SINR. The L1-SINR related to a CSI-RS may be referred to as CSI-SINR.

Information related to the NCBI-RS (for example, resources, numbers, the number of ports, precoding, and the like for the RS), information related to new candidate beam identification (NCBI) (for example, the above-mentioned threshold value), and the like may be configured (notified) for the UE with use of higher layer signaling or the like. The information related to the NCBI-RS may be obtained on the basis of information related to the BFD-RS. The information related to the NCBI-RS may be referred to as information related to resources for NCBI and so on.

Note that the BFD-RS, the NCBI-RS, and the like may be interpreted as a radio link monitoring reference signal (RLM-RS (Radio Link Monitoring RS)).

At step S104, the UE that has identified the new candidate beam transmits a beam recovery request (Beam Failure Recovery reQuest (BFRQ)). The beam recovery request may be referred to as a beam recovery request signal, a beam failure recovery request signal, and so on.

The BFRQ may be transmitted with use of, for example, a random access channel (Physical Random Access Channel (PRACH)). The BFRQ may include information about the new candidate beam identified at step S103. Resources for the BFRQ may be associated with the new candidate beam. The information about the beam may be notified with use of a beam index (BI), a port index of a certain reference signal, a resource index (for example, a CSI-RS resource indicator (CRI)), an SSB resource indicator (SSBRI), or the like.

In Rel. 15 NR, CB-BFR (Contention-Based BFR) that is BFR based on collision type (or contention type) random access (Contention based Random Access (CBRA)) procedure and CF-BFR (Contention-Free BFR) that is BFR based on non-collision type (or non-contention type) random access (Contention-Free Random Access (CFRA)) procedure are supported. In the CB-BFR and the CF-BFR, the UE may transmit a preamble (also referred to as an RA preamble, a random access channel (Physical Random Access Channel (PRACH)), a RACH preamble, and so on) as the BFRQ by using PRACH resources.

Note that the CF-BFR may be referred to as CFRA BFR. The CB-BFR may be referred to as CBRA BFR. The CFRA procedure and CFRA may be interchangeably interpreted. The CBRA procedure and CBRA may be interchangeably interpreted.

At step S105, the base station that has detected the BFRQ transmits a response signal (which may be referred to as BFR response, gNB response, and so on) to the BFRQ from the UE. The response signal may include reconfiguration information (for example, DL-RS resource configuration information) about one or a plurality of beams.

The response signal may be transmitted in, for example, a UE-common search space of a PDCCH. The response signal may be notified with use of a PDCCH (DCI) having a cyclic redundancy check (CRC) scrambled by a UE identifier (for example, a cell-radio network temporary identifier (C-RNTI)). The UE may judge, on the basis of beam reconfiguration information, at least one of a transmit beam and a receive beam to be used.

The UE may monitor the response signal on the basis of at least one of a control resource set (COntrol REsource SET (CORESET)) for BFR and a search space set for BFR. For example, the UE may detect, in a BFR search space in an individually configured CORESET, the DCI having the CRC scrambled by the C-RNTI.

With respect to the CB-BFR, when the UE receives the PDCCH corresponding to the C-RNTI related to the UE itself, it may be judged that contention resolution has succeeded.

With respect to processing at step S105, a period for the UE to monitor response from the base station (for example, gNB) to the BFRQ may be configured. The period may be referred to as, for example, a gNB response window, a gNB window, a beam recovery request response window, a BFRQ response window, and so on. The UE may perform retransmission of the BFRQ when there is no gNB response detected in the window period.

At step S106, the UE may transmit a message indicating that beam reconfiguration for the base station has been completed. For example, the message may be transmitted by a PUCCH, or may be transmitted by a PUSCH.

At step S106, the UE may receive RRC signaling indicating a configuration of a transmission configuration indication state (TCI state) used for a PDCCH, or may receive a MAC CE indicating activation of the configuration.

Beam recovery success (BR success) may represent, for example, a case where step S106 has been reached. On the other hand, beam recovery failure (BR failure) may correspond to, for example, a case that BFRQ transmission has reached a certain number of times or a case that a beam failure recovery timer (Beam-failure-recovery-Timer) has expired.

Note that these step numbers are just numbers for description, and a plurality of steps may be combined with each other, or the order of the steps may be switched. Whether to perform the BFR may be configured for the UE with use of higher layer signaling.

### (BFD-RS)

In Rel. 16, for each BWP of one serving cell, set q₀ bar of periodic (P)-CSI-RS resource configuration indices and set q₁ bar of at least one of P-CSI-RS resource configuration indices and SS/PBCH block indices can be provided for the UE by failure detection resources (failureDetectionResources) and by a candidate beam RS list (candidateBeamRSList), an extended candidate beam RS list (candidateBeamRSListExt-r16), or a candidate beam RS list for an SCell (candidateBeamRSSCellList-r16), respectively.

The q₀ bar is an expression in which an overline is added to “q₀.” Hereinafter, the q₀ bar is simply expressed as q₀. The q₁ bar is an expression in which an overline is added to “q₁.” Hereinafter, the q₁ bar is simply expressed as q₁.

The UE may perform L1-RSRP measurement and the like by using RS resources corresponding to indices included in at least one set of set q₀ and set q₁ to detect beam failure.

Note that in the present disclosure, a case that the above-mentioned higher layer parameter indicating information about an index corresponding to BFD resources is provided and each of a case that BFD resources are configured, a case that a BFD-RS is configured, and the like may be interchangeably interpreted. In the present disclosure, the BFD resources, set q₀ of periodic CSI-RS resource configuration indices or SSB indices, and a BFD-RS may be interchangeably interpreted.

If q₀ is not provided for the UE by failure detection resources (failureDetectionResources) or a beam failure detection resource list (beamFailureDetectionResourceList) for one BWP of the serving cell, the UE determines that a P-CSI-RS resource configuration index having the same value as an RS index in an RS set indicated by a TCI state (TCI-State) for a corresponding CORESET is included in set q₀, the CORESET being used for PDCCH monitoring. If two RS indices are present in one TCI state, set q₀ includes an RS index having a QCL type D configuration for a corresponding TCI state. The UE assumes that set q₀ includes up to two RS indices. The UE assumes a single port RS in set q₀.

With respect to the BFR, the UE may follow at least one of the following operation 1 (BFR for an SCell) and operation 2 (BFR for an SpCell).

### {Operation 1}

A configuration for PUCCH transmission having a link recovery request (LRR) may be provided for the UE by a scheduling request ID for BFR (schedulingRequestIDForBFR). The UE can transmit, in a first PUSCH, at least one MAC CE (BFR MAC CE) to provide one index for at least one corresponding SCell having radio link quality being worse than Q_{out,LR}. This index is index q_{new} for a P-CSI-RS configuration or an SS/PBCH block, the index being provided by a higher layer for a corresponding SCell, if configured. After 28 symbols from the last symbol of specific PDCCH reception, the UE may follow at least one of the following operation 1-1 and operation 1-2. The specific PDCCH reception has a DCI format that schedules PUSCH transmission having the same HARQ process number as that of transmission of the first PUSCH and that has a toggled new data indicator (NDI) field value.

### {{Operation 1-1}}

The UE monitors a PDCCH in all CORESETs on an SCell indicated by the MAC CE by using the same antenna port QCL parameter as an antenna port QCL parameter associated with corresponding index q_{new}, if any.

### {{Operation 1-2}}

The UE transmits a PUCCH on a PUCCH-SCell by using the same spatial domain filter as a spatial domain filter corresponding to index q_{new} and by using power with qᵤ=0, q_{d}=q_{new}, and l=0 in an expression for transmit power if the following condition 1 to condition 3 are satisfied.
{{Condition 1}} PUCCH spatial relation information (PUCCH-SpatialRelationInfo) for a PUCCH is provided for the UE.
{{Condition 2}} A PUCCH having the LRR has not been transmitted or has been transmitted on a PCell or a PSCell.
{{Condition 3}} The PUCCH-SCell is included in the SCell indicated by the MAC CE.

Here, subcarrier spacing (SCS) configuration for the above-described 28 symbols is a minimum value of SCS configuration of an active DL BWP for PDCCH reception and SCS configuration of an active DL BWP for at least one SCell.

q_{new} may be an index of a new candidate beam (for example, an SSB/CSI-RS) selected by the UE and reported to a network with use of a corresponding PRACH in the BFR procedure (or an index of a new beam detected in the BFR procedure).

In a normal case, qᵤ may be PO ID for a PUCCH (p0-PUCCH-Id) indicating PO for the PUCCH (PO-PUCCH) in PO set (p0-Set) for the PUCCH. l may be referred to as a power control adjustment state index, a PUCCH power control adjustment state index, a closed-loop index, and so on. q_{d} may be an index of a path loss reference RS (configured by, for example, PUCCH-PathlossReferenceRS).

### {Operation 2}

The UE may receive a PRACH transmission configuration (PRACH-ResourceDedicatedBFR). For PRACH transmission in slot n following an antenna port QCL parameter that is associated with index q_{new} provided by the higher layer and that is associated with a P-CSI-RS resource configuration or an SS/PBCH block, the UE monitors a specific PDCCH. The specific PDCCH is a PDCCH in a search space set provided by a recovery search space ID (recoverySearchSpaceId) for detection of a DCI format having a CRC scrambled by a C-RNTI or an MCS-C-RNTI starting from slot n+4 in a window configured by beam failure recovery configuration (BeamFailureRecoveryConfig). For PDCCH monitoring in the search space set provided by the recovery search space ID and corresponding PDSCH reception, the UE assumes the same antenna port QCL parameter as an antenna port QCL parameter associated with index q_{new} until the UE receives activation of at least one parameter of a TCI state or a TCI state add-list (tci-StatesPDCCH-ToAddList) for the PDCCH and a TCI state release list (tci-StatesPDCCH-ToReleaseList) for the PDCCH by using the higher layer.

The UE may follow the following operation 2-1.

### {{Operation 2-1}}

After the UE detects, in the search space set provided by the recovery search space ID, the DCI format having the CRC scrambled by the C-RNTI or the MCS-C-RNTI, the UE continues to monitor PDCCH candidates in the search space set provided by the recovery search space ID until the UE receives a MAC CE activation command for at least one of the TCI state or the TCI state add-list for the PDCCH and the TCI state release list for the PDCCH.

For BFR for a PCell/SCell (SpCell/SCell) based on the CBRA/CFRA procedure, the BFD-RS may be explicitly configured by RRC, or may not be configured. When the BFD-RS is not configured, the UE assumes, as the BFD-RS, a periodic (P)-CSI-RS or an SSB having QCL type D with the PDCCH. In Rel. 15/16, the UE can monitor up to two BFD-RSs.

In Rel. 15/16, until an explicitly configured BFD-RS (explicit BFD-RS) is reconfigured or disabled by RRC, the UE continues to monitor the BFD-RS. When the BFD-RS is explicitly configured by the RRC, also after completion of BFR in response to occurrence of BFD, there is a case where BFR occurs again if the UE performs BFD by using the BFD-RS.

For example, in a case where P-CSI-RS #1 is configured as the BFD-RS by the RRC, it is conceivable that, when BFR is performed, a beam different from P-CSI-RS #1 (TCI state for which P-CSI-RS #1 is configured as QCL type D) is used for a PDCCH after the BFR. According to existing specifications, measurement of BFD after the BFR is performed with use of P-CSI-RS #1 configured before the BFR. In other words, even when quality of actual communication is satisfactory, BFD is performed with use of a BFD-RS irrelevant to the communication quality, and thus there is a case where BFR is performed again (repetitively).

Thus, for operation 1, the UE that, when an explicit BFD-RS is configured before beam failure in an SCell, suspends monitoring of the explicit BFD-RS after receiving SCell BFR response is under study. For example, when performing at least one of the above-mentioned operation 1-1 and operation 1-2, the UE performs the following operation 1-3.

### {{Operation 1-3}}

If set q₀ is provided by a failure detection resource (failureDetectionResource) or a beam failure detection resource list (BeamFailureDetectionResourceList, failureDetectionResourcesToAddModList) of a higher layer parameter, the UE suspends monitoring of set q₀.

For operation 2, the UE that, when an explicit BFD-RS is configured before beam failure in an SpCell, suspends monitoring of the explicit BFD-RS after receiving SpCell BFR response is under study. For example, the UE that performs the following operation 2-2 in place of the above-mentioned operation 2-1 is under study.

### {{Operation 2-2}}

After the UE detects, in the search space set provided by the recovery search space ID, the DCI format having the CRC scrambled by the C-RNTI or the MCS-C-RNTI, the UE continues to monitor PDCCH candidates in the search space set provided by the recovery search space ID until the UE receives the MAC CE activation command for at least one of the TCI state or the TCI state add-list for the PDCCH and the TCI state release list for the PDCCH, and the UE suspends monitoring of set q₀ if set q₀ is provided by the failure detection resource (failureDetectionResource).

Enhancement related to beam management for simultaneous multi-TRP transmission using multi-panel reception is under study. However, an implicit BFD RS for multiple TRPs for each TRP/for each link is indefinite.

For a case where implicit BFD RS configuration is used, the following option 1 and option 2 are under study.

### {Option 1}

BFD-RS set k may be derived from a QCL type D RS with a TCI state of a CORESET configured in CORESET subset k. For example, k is 0 or 1. When the QCL type D RS is not configured, BFD-RS set k may be derived from QCL type A with the TCI state of the CORESET configured in CORESET subset k. This option may be employed in multiple TRPs based on single DCI and in multiple TRPs based on multiple DCI.

### {Option 2}

BFD-RS set k may be derived from a QCL type D RS with a TCI state of a CORESET configured in CORESET pool index k. For example, k is 0 or 1. When the QCL type D RS is not configured, BFD-RS set k may be derived from QCL type A with the TCI state of the CORESET configured in CORESET pool index k. This option may be employed in multiple TRPs based on multiple DCI.

Option 2 is preferable for the multiple TRPs based on multiple DCI. However, there is a possibility that there is no CORESET subset configuration for the multiple TRPs based on single DCI (the CORESET subset configuration is similar to that for the multiple TRPs based on multiple DCI). In this case, option 1 does not operate.

Thus, the inventors of the present invention came up with the idea of an operation for a method of determining the implicit BFD RS.

Analysis #1: multiple TRPs based on single DCI are determined by transmission of a MAC CE for enhanced TCI state activation/deactivation for a UE-specific PDSCH (Enhanced TCI states Activation/Deactivation for UE-specific PDSCH MAC CE), and one codepoint of the DCI (TCI field) corresponds to two activated TCI states. The implicit BFD RS may be determined by this MAC CE.

Analysis #2: inter-cell management for multiple TRPs is under discussion. A non-serving cell RS (SSB/CSI-RS) may be configured/associated as a QCL source RS in TCI state configuration with use of any one of a new flag, a new ID, and a new physical cell ID (PCI). In this case, the implicit BFD RS may be determined on the basis of such a non-serving cell TCI.

Embodiments according to the present disclosure will be described in detail with reference to the drawings as follows. The radio communication methods according to respective embodiments may each be employed individually, or may be employed in combination.

In the present disclosure, “A/B/C” and “at least one of A, B, and C” may be interchangeably interpreted. In the present disclosure, a cell, a serving cell, a CC, a carrier, a BWP, a DL BWP, a UL BWP, an active DL BWP, an active UL BWP, and a band may be interchangeably interpreted. In the present disclosure, an index, an ID, an indicator, and a resource ID may be interchangeably interpreted. In the present disclosure, “support,” “control,” “controllable,” “operate,” and “operable” may be interchangeably interpreted.

In the present disclosure, “configure,” “activate,” “update,” “indicate,” “enable,” “specify,” and “select” may be interchangeably interpreted.

In the present disclosure, the higher layer signaling may be, for example, any one or combinations of Radio Resource Control (RRC) signaling, Medium Access Control (MAC) signaling, broadcast information, and the like. In the present disclosure, RRC, RRC signaling, an RRC parameter, a higher layer, a higher layer parameter, an RRC information element (IE), and an RRC message may be interchangeably interpreted.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, a MAC CE and an activation/deactivation command may be interchangeably interpreted.

In the present disclosure, a beam, a spatial domain filter, a spatial setting, a TCI state, a UL TCI state, a unified TCI state, a unified beam, a common TCI state, a common beam, TCI assumption, QCL assumption, a QCL parameter, a spatial domain reception filter, a UE spatial domain reception filter, a UE receive beam, a DL beam, a DL receive beam, DL precoding, a DL precoder, a DL-RS, an RS of QCL type D in a TCI state/QCL assumption, an RS of QCL type A in a TCI state/QCL assumption, a spatial relation, a spatial domain transmission filter, a UE spatial domain transmission filter, a UE transmit beam, a UL beam, a UL transmit beam, UL precoding, a UL precoder, and a PL-RS may be interchangeably interpreted. In the present disclosure, a QCL type X-RS, a DL-RS associated with QCL type X, and a DL-RS, a DL-RS source, an SSB, a CSI-RS, or an SRS having QCL type X may be interchangeably interpreted.

In the present disclosure, a panel, an Uplink (UL) transmission entity, a TRP, a spatial relation, a control resource set (CORESET), a PDSCH, a code word, a base station, an antenna port for a certain signal (for example, a demodulation reference signal (DMRS) port), an antenna port group for a certain signal (for example, a DMRS port group), a group for multiplexing (for example, a code division multiplexing (CDM) group, a reference signal group, or a CORESET group), a CORESET pool, a CORESET subset, a CW, a redundancy version (RV), and a layer (MIMO layer, transmission layer, spatial layer) may be interchangeably interpreted. A panel Identifier (ID) and a panel may be interchangeably interpreted. In the present disclosure, a TRP ID and a TRP may be interchangeably interpreted.

In the present disclosure, a TRP, a transmission point, a panel, a DMRS port group, a CORESET pool, and one of two TCI states associated with one codepoint of a TCI field may be interchangeably interpreted.

In the present disclosure, a single TRP, a single TRP system, single TRP transmission, and a single PDSCH may be interchangeably interpreted. In the present disclosure, multiple TRPs, a multi-TRP system, multi-TRP transmission, and multiple PDSCHs may be interchangeably interpreted. In the present disclosure, single DCI, a single PDCCH, multiple TRPs based on single DCI, and activation of two TCI states on at least one TCI codepoint may be interchangeably interpreted.

In the present disclosure, a single TRP, a channel using a single TRP, a channel using one TCI state/spatial relation, a case that multiple TRPs are not enabled by RRC/DCI, a case that a plurality of TCI states/spatial relations are not enabled by RRC/DCI, and a case that one CORESET pool index (CORESETPoolIndex) value is not configured for any CORESET, and any codepoint of a TCI field is not mapped to two TCI states may be interchangeably interpreted.

In the present disclosure, multiple TRPs, a channel using multiple TRPs, a channel using a plurality of TCI states/spatial relations, a case that multiple TRPs are enabled by RRC/DCI, a case that a plurality of TCI states/spatial relations are enabled by RRC/DCI, and at least one of multiple TRPs based on single DCI and multiple TRPs based on multiple DCI may be interchangeably interpreted. In the present disclosure, multiple TRPs based on multiple DCI and a case that one CORESET pool index (CORESETPoolIndex) value is configured for a CORESET may be interchangeably interpreted. In the present disclosure, multiple TRPs based on single DCI and a case that at least one TCI codepoint of a TCI field is mapped to two TCI states may be interchangeably interpreted.

In the present disclosure, TRP #1 (first TRP) may correspond to a CORESET pool index=0, or may correspond to the first TCI state out of two TCI states corresponding to one codepoint of a TCI field. TRP #2 (second TRP) may correspond to a CORESET pool index=1, or may correspond to the second TCI state out of the two TCI states corresponding to one codepoint of the TCI field.

In the present disclosure, a DMRS, a DMRS port, and an antenna port may be interchangeably interpreted.

UL DCI, DCI to schedule a UL channel (for example, a PUSCH), and DCI format 0_x (x=0, 1, 2, . . . ) may be interchangeably interpreted. DL DCI, DCI to schedule a DL channel (PDSCH), and DCI format 1_x (x=0, 1, 2, . . . ) may be interchangeably interpreted.

In the present disclosure, a link direction, downlink (DL), uplink (UL), and one of UL and DL may be interchangeably interpreted.

In the present disclosure, a pool, a set, a group, and a list may be interchangeably interpreted.

In the present disclosure, a common beam, a common TCI, a common TCI state, a unified TCI, a unified TCI state, a TCI state applicable to DL and UL, a TCI state applied to a plurality (multiple types) of channels/RSs, a TCI state applicable to multiple types of channels/RSs, and a PL-RS may be interchangeably interpreted.

In the present disclosure, a plurality of TCI states configured by RRC, a plurality of TCI states activated by a MAC CE, a pool, a TCI state pool, an active TCI state pool, a common TCI state pool, a joint TCI state pool, a separate TCI state pool, a UL common TCI state pool, a DL common TCI state pool, a common TCI state pool configured/activated by RRC/MAC CE, and TCI state information may be interchangeably interpreted.

In the present disclosure, a MAC CE and an activation command may be interchangeably interpreted.

### (Radio Communication Method)

### First Embodiment

For multiple TRPs based on single DCI, when BFR for each TRP is configured by RRC (a MAC CE for enhanced TCI state activation/deactivation for a UE-specific PDSCH is transmitted) and a BFD RS is not configured explicitly, the BFD RS may be determined implicitly. In this case, the BFD RS may follow any one of the following option 1 and option 2.

### {Option 1}

The BFD RS may follow Rel. 16.

This means that an implicit BFD RS for each TRP/for each link is absent if two sets of BFD RSs are not configured explicitly. If the two sets of BFD RSs are not configured explicitly, only an implicit BFD RS for each cell is present. TRP information is irrelevant (transparent) to BFDD RS q₀.

### {Option 2}

The BFD RS may follow a sixth embodiment.

This means that an implicit BFD RS for each TRP/for each link is absent if two sets of BFD RSs are not configured explicitly. If the two sets of BFD RSs are not configured explicitly, only an implicit BFD RS for each cell is present. When BFDD RS q₀ is determined, the TRP information is considered (only one set q₀ is determined).

According to this embodiment, a UE can determine a BFD RS appropriately even when the BFD RS is not configured explicitly.

### Second Embodiment

When BFR for each TRP is configured, and a MAC CE for enhanced TCI state activation/deactivation for a UE-specific PDSCH is transmitted, and one codepoint of DCI (TCI field) corresponds to two activated TCI states (multiple TRPs based on single DCI), two sets of implicit BFD RSs may be determined, and the two sets may be determined as RSs indicated/indexed in any one of the following option 1 to option 5.

### {Option 1}

The two sets of implicit BFD RSs are two TCI states corresponding to the lowest codepoint out of TCI codepoints including two different TCI states activated by the MAC CE for the PDSCH. Each BFD RS set includes RSs in one TCI. If two RS indices are present in one TCI state, an RS index having QCL type D is included in that BFD RS set.

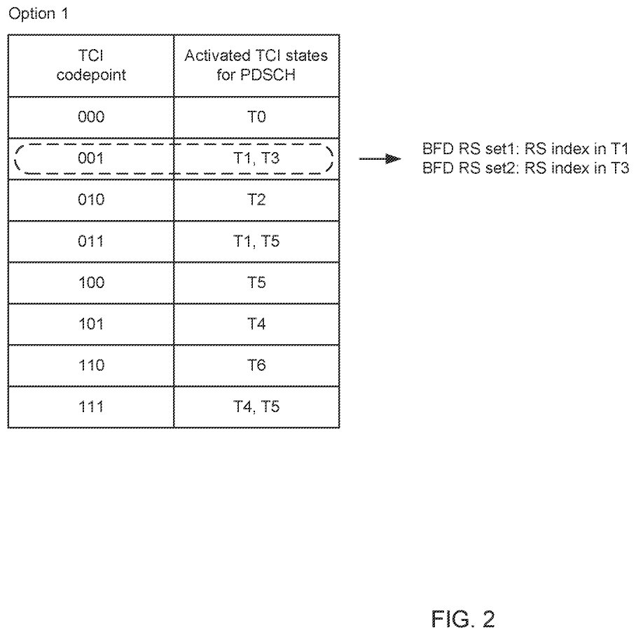

In an example of FIG. 2, two active TCI states corresponding to lowest codepoint 001 out of TCI codepoints associated with two different active TCI states correspond to respective two BFD RS sets 1 and 2. BFD RS set 1 is first TCI state T1 of the two active TCI states, and BFD RS set 2 is second TCI state T3 of the two active TCI states.

This option ensures that each set of the BFD RSs is from one TRP, but does not consider a CORESET TCI.

### {Option 2}

The two sets of implicit BFD RSs are two TCI states corresponding to the lowest codepoint out of TCI codepoints including two different TCI states that are activated by the MAC CE for the PDSCH and that correspond to TCI states of two CORESETs monitored by a UE. Each BFD RS set includes RSs in one TCI. If two RS indices are present in one TCI state, an RS index having QCL type D is included in that BFD RS set.

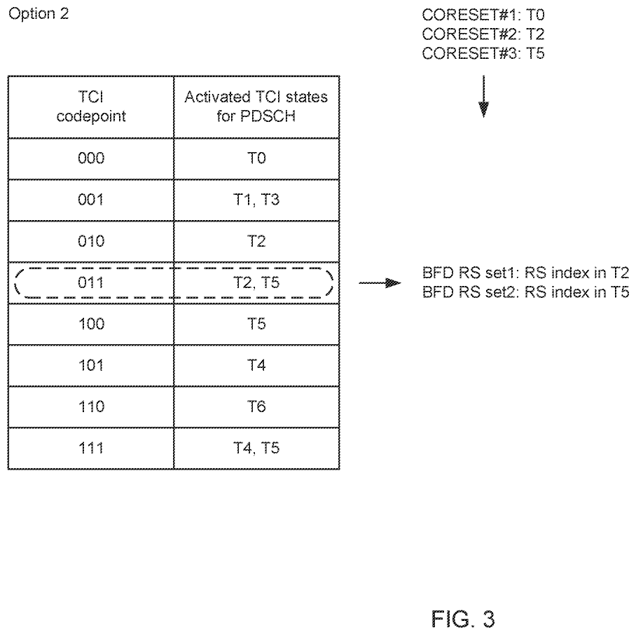

In an example of FIG. 3, two active TCI states corresponding to lowest codepoint 011 out of TCI codepoints associated with two different active TCI states associated with two CORESETs correspond to respective two BFD RS sets 1 and 2. BFD RS set 1 is first TCI state T2 of the two active TCI states, and BFD RS set 2 is second TCI state T5 of the two active TCI states.

This option ensures that each set of the BFD RSs is from one TRP and corresponds to one CORESET.

### {Option 3}

The two sets of implicit BFD RSs are based on option 2. If the two CORESETs in option 2 are not found, the UE may be defined as a UE that should not assume the two sets of implicit BFD RSs, or may be defined as a UE that assumes any one of the following option 1 and option 2.

### {{Option 1}}

Determination of an implicit BFD RS may fall back to determination of an implicit BFD RS for each cell (the first embodiment).

### {{Option 2}}

In this case, the implicit BFD RS (BFD/BFR) may not be supported/performed.

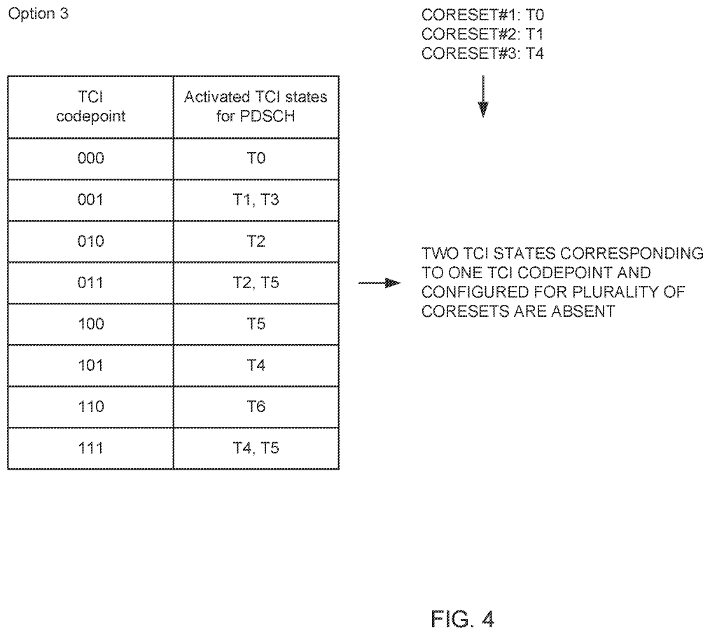

In an example of FIG. 4, TCI codepoints associated with two different active TCI states associated with two CORESETs are absent. In this case, the UE may follow option 3.

### {Option 4}

The implicit BFD RS is one or a plurality of TCI states notified by another MAC CE.

### {Option 5}

The implicit BFD RS is one or a plurality of common TCI states notified by a MAC CE in accordance with a common TCI state framework.

According to this embodiment, the UE can determine a BFD RS appropriately even when the BFD RS is not configured explicitly.

### Third Embodiment

When BFR for each TRP is configured, and a non-serving cell RS is configured/associated as a QCL source RS in TCI state configuration, and such a TCI state is configured for a CORESET, one set of implicit BFD RSs may be determined.

One set of BFD RSs may be determined as an RS index in a CORESET TCI state having a serving cell RS as the QCL source RS. The other set of BFD RSs may be determined as an RS index in a CORESET TCI state having a non-serving cell RS as the QCL source RS. If two RS indices are present in one TCI state, an RS index having QCL type D may be included in a BFD RS set.

The RS index of each set of BFD RSs may follow any one of the following option 1 and option 2.

### {Option 1}

The RS index of each set of BFD RSs may be a TCI state having the lowest TCI state ID out of CORESET TCI states having serving cell or non-serving cell RSs.

### {Option 2}

The RS index of each set of BFD RSs may be a TCI state for the lowest CORESET ID out of CORESET TCI states having serving cell or non-serving cell RSs.

In a case where a TCI state for a PDCCH/CORESET is configured/associated for the non-serving cell RS, a third embodiment may be employed in at least one of multiple TRPs based on single DCI and multiple TRPs based on multiple DCI.

Non-serving cell information having information different from that for a serving cell may be configured in the TCI state, or an association with the TCI state may be configured for the non-serving cell information. The information may be a flag indicating whether a serving cell or a non-serving cell, may be an index of a re-indexed non-serving cell, or may be a PCI.

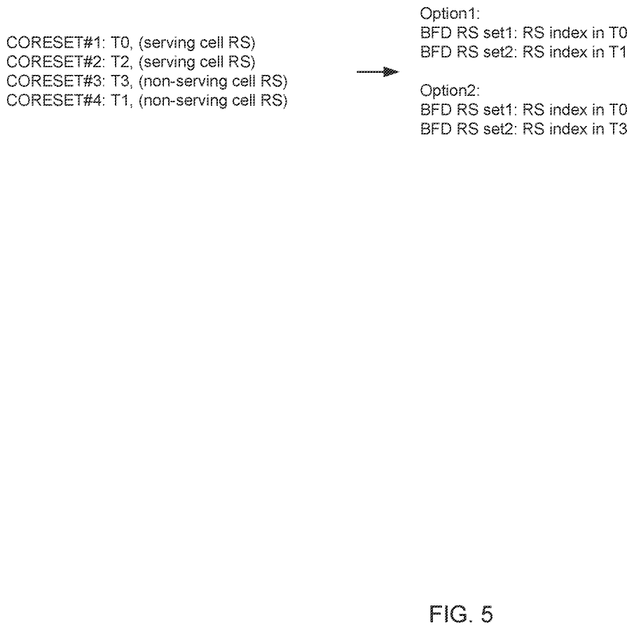

In an example of FIG. 5, TCI state T0 being a serving cell RS is configured for CORESET #1, TCI state T2 being a serving cell RS is configured for CORESET #2, TCI state T3 being a non-serving cell RS is configured for CORESET #3, and TCI state T1 being a non-serving cell RS is configured for CORESET #1. When option 1 is employed, BFD RS set 1 is an RS index in T0, and BFD RS set 2 is an RS index in T1. When option 2 is employed, BFD RS set 1 is an RS index in T0, and BFD RS set 2 is an RS index in T3.

According to this embodiment, a UE can determine a BFD RS appropriately even when the BFD RS is not configured explicitly.

### Fourth Embodiment

In multiple TRPs based on multiple DCI, a UE may select a CORESET for each CORESET pool index on the basis of a certain rule, and may determine a BFD RS. The UE may select, on the basis of the certain rule, a CORESET from a CORESET for which CORESET pool index 0 has been configured and CORESETs without configuration of a CORESET pool index, and may determine a TCI state/QCL of the CORESET as the BFD RS. The UE may select, on the basis of the certain rule, a CORESET from CORESETs for which CORESET pool index=1 has been configured, and may determine a TCI state/QCL of the CORESET as the BFD RS.

The certain rule may follow any one of the first to third embodiments and the sixth embodiment.

According to this embodiment, the UE can determine a BFD RS appropriately even when the BFD RS is not configured explicitly.

### Fifth Embodiment

A UE capability corresponding to at least one function (characteristic, feature) in the first to fourth embodiments may be defined. When a UE has reported this UE capability, the UE may perform a corresponding function. When the UE has reported this UE capability, and a higher layer parameter corresponding to this function has been configured for the UE, the UE may perform a corresponding function. The higher layer parameter (RRC information element) corresponding to this function may be defined. When this higher layer parameter has been configured, the UE may perform a corresponding function.

The UE capability may indicate whether the UE supports this function.

The UE capability may indicate whether to support, for multiple TRPs/multiple TRPs based on single DCI/multiple TRPs based on multiple DCI, (two sets of) implicit BFD RSs for BFR for each TRP/for each link.

According to this embodiment, the UE can achieve the above-described function while maintaining compatibility with existing specifications.

### Sixth Embodiment

### <<RS Determination Method 1>>

When an RLM-RS is not provided (is not explicitly configured by RRC signaling) for a UE, the UE may select N_{RLM} RLM-RSs in accordance with an RLM-RS determination rule in NR Rel. 15. In this case, the UE may determine, as the RLM-RSs, RSs with TCI states associated with at least one TRP.

Similarly to the RLM-RS determination rule in a case where Lₘₐₓ=4, the UE may select N_{RLM} RSs corresponding to Lₘₐₓ greater than 4, such as Lₘₐₓ=8 or Lₘₐₓ=64.

The RLM-RS determination rule may be one of the following rule 1-1 to rule 1-4.

### <<Rule 1-1>> (Similar to the RLM-RS Determination Rule of NR Rel. 15)

The UE may select, in sequence starting from the shortest monitoring periodicity of a search space set, N_{RLM} RSs provided for active TCI states for PDCCH reception in CORESETs associated with search space sets. When more than one CORESET is associated with search space sets having the same monitoring periodicity, the UE may determine a CORESET sequence starting from the highest CORESET index.

### <<Rule 1-2>>

The UE may select, in sequence starting from the shortest monitoring periodicity of a search space set, N_{RLM} RSs provided for active TCI states for PDCCH reception in CORESETs associated with search space sets. When more than one CORESET is associated with search space sets having the same monitoring periodicity, the UE may determine a CORESET sequence starting from the lowest CORESET index.

### <<Rule 1-3>>

The UE may select, in sequence starting from the longest monitoring periodicity of a search space set, N_{RLM} RSs provided for active TCI states for PDCCH reception in CORESETs associated with search space sets. When more than one CORESET is associated with search space sets having the same monitoring periodicity, the UE may determine a CORESET sequence starting from the highest CORESET index.

### <<Rule 1-4>>

The UE may select, in sequence starting from the longest monitoring periodicity of a search space set, N_{RLM} RSs provided for active TCI states for PDCCH reception in CORESETs associated with search space sets. When more than one CORESET is associated with search space sets having the same monitoring periodicity, the UE may determine a CORESET sequence starting from the lowest CORESET index.

In a case of selecting the N_{RLM} RSs in order starting from the longest monitoring periodicity (rule 1-3, rule 1-4), when failure occurs frequently in a PDCCH having the longest monitoring periodicity, the failure can be reduced by RLM.

In a case of selecting the N_{RLM} RSs in order starting from the lowest CORESET ID (rule 1-2, rule 1-4), a specific CORESET such as CORESET 0 can be given priority in selection.

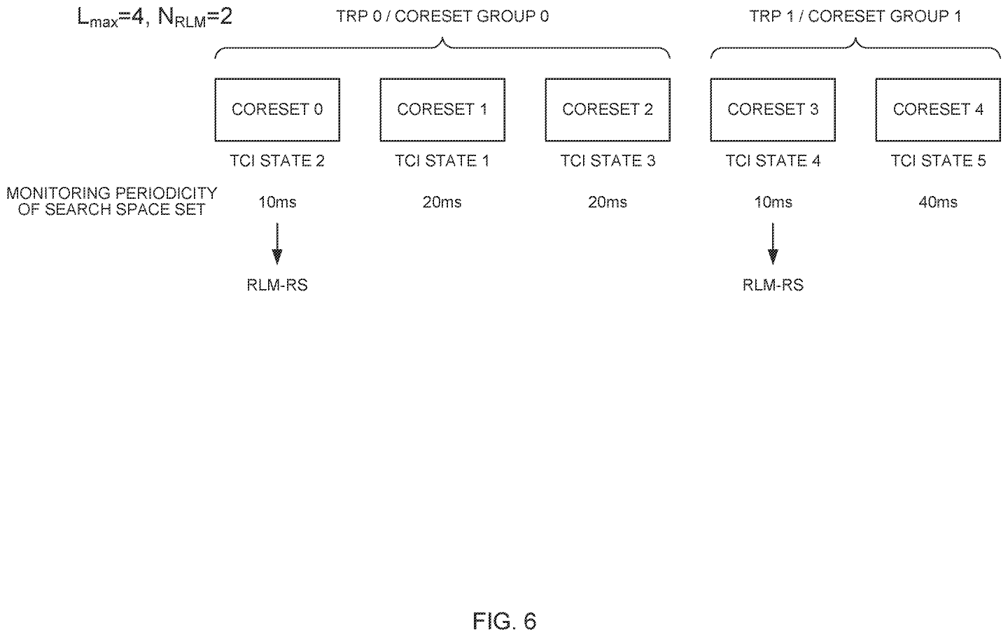

In FIG. 6, CORESET group 0 corresponds to TRP 0, and includes CORESET 0, CORESET 1, and CORESET 2. CORESET group 1 corresponds to TRP 1, and includes CORESET 3 and CORESET 4. Monitoring periodicities of search space sets associated with CORESET 0, CORESET 1, CORESET 2, CORESET 3, and CORESET 4 are 10, 20, 20, 10, and 40 ms, respectively. TCI states for PDCCHs in CORESET 0, CORESET 1, CORESET 2, CORESET 3, and CORESET 4 are TCI state 2, TCI state 1, TCI state 3, TCI state 4, and TCI state 5, respectively.

In this example, Lₘₐₓ=4 and N_{RLM}=2, and the UE uses rule 1-1.

The UE selects, in order of a monitoring periodicity, TCI state 2 and TCI state 4 for PDCCHs in CORESET 0 and CORESET 3 associated with search space sets having the shortest monitoring periodicity 10 ms, out of CORESETs in all CORESET groups. With this operation, the UE determines RSs with selected TCI state 2 and TCI state 4 as N_{RLM} (2) RLM-RSs.

According to RS determination method 1 above, also in a case where Lₘₐₓ=8 and N_{RLM}=4, the UE can determine an RLM-RS.

### <<RS Determination Method 2>>

In an RLM-RS determination rule of NR Rel. 15 or RS determination method 1, a limitation that an active TCI state for PDCCH reception in CORESETs having the lowest or highest TRP-related ID is used may be added.

PDCCH configuration information (for example, PDCCH-Config) may include CORESET information (for example, controlResourceSet) and search space information (for example, searchSpace). The CORESET information may include a CORESET ID (index, for example, controlResourceSetId) and a CORESET group ID. The CORESET group ID may be an ID corresponding to at least one of a PDSCH, a codeword, a DMRS port group, a panel, and a TRP.

When RadioLinkMonitoringRS is not provided for the UE, and a TCI state including one or more CSI-RSs for a PDCCH in a CORESET having the lowest or highest TRP-related ID is provided for the UE:
When an active TCI state for PDCCH reception in the CORESET having the lowest or highest TRP-related ID includes only one RS, the UE may use, for RLM, an RS provided for a TCI state for the active TCI state for the PDCCH.
When the active TCI state for the PDCCH reception in the CORESET having the lowest or highest TRP-related ID includes two RSs, the UE expects that one RS has QCL type D, the UE uses the RS having QCL type D for RLM, and the UE does not expect that both of the RSs have QCL type D.
The UE may not be required to use an aperiodic or semi-persistent RS for RLM.
For Lₘₐₓ=4, the UE may select, in sequence starting from the shortest monitoring periodicity of a search space set, N_{RLM} RSs provided for active TCI states for PDCCH reception in CORESETs associated with search space sets, out of CORESETs having the lowest or highest TRP-related ID. When more than one CORESET is associated with search space sets having the same monitoring periodicity, the UE may determine a CORESET sequence starting from the highest CORESET index.

When RadioLinkMonitoringRS is not provided for the UE, the UE may not expect that more than N_{RLM} RadioLinkMonitoringRSs are used for RLM.

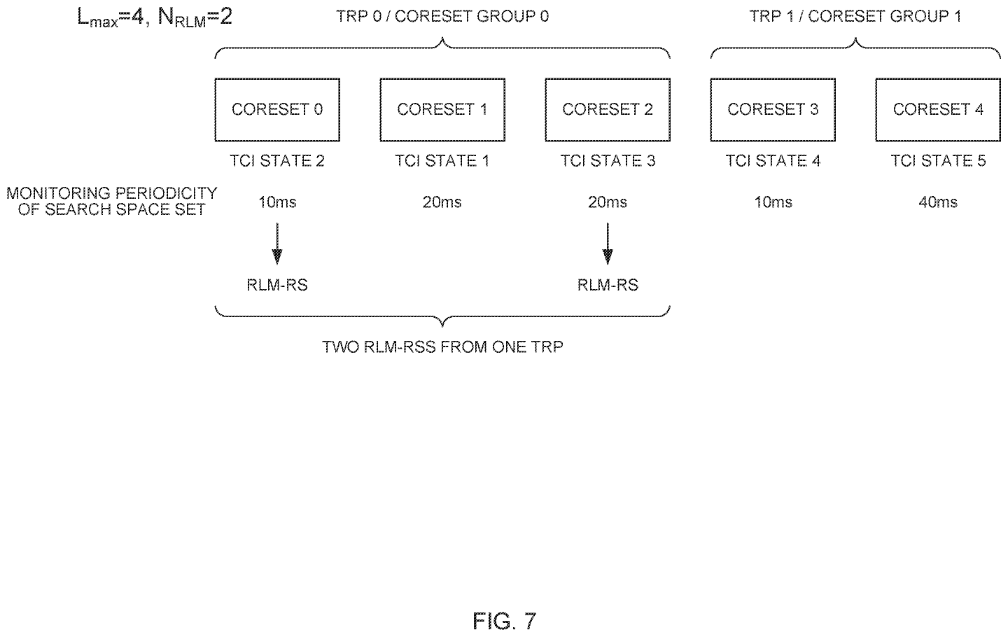

In FIG. 7, a configuration of TRPs, CORESET groups, CORESETs, monitoring periodicities of search space sets, and TCI states is similar to that of FIG. 6.

In this example, Lₘₐₓ=4 and N_{RLM}=2, and the UE uses rule 1-1.

In this example, assume that limitation to the RLM-RS determination rule is that the PDCCH is a PDCCH in a CORESET having the lowest CORESET group ID. In this example, the UE limits the RLM-RSs to active TCI states for PDCCHs in CORESETs in CORESET group 0 (TRP 0).

The UE selects, in order of a monitoring periodicity, TCI state 2 for a PDCCH in CORESET 0 associated with a search space set having the shortest monitoring periodicity 10 ms, out of CORESETs having the lowest CORESET group ID, and selects TCI state 3 for a PDCCH in CORESET 2 having the highest CORESET index, out of two CORESETs associated with a search space set having the second shortest monitoring periodicity 20 ms. With this operation, the UE determines, from CORESET group 0 corresponding to one TRP, RSs with TCI state 2 and TCI state 3 as two RLM-RSs.

In NR Rel. 15, the UE has an RRC connection to one TRP, and thus an RLM-RS is associated with only this TRP. According to RS determination method 2, a plurality of RLM-RSs associated with a specific TRP (connected TRP, default TRP) are selected, and thus RLM for the specific TRP can be certainly performed.

### <<RS Determination Method 3>>

In the RLM-RS determination rule of NR Rel. 15 or RS determination method 1, enhancement in which the UE uses, as the RLM-RSs, two RSs each provided for an active TCI state for PDCCH reception in CORESETs having two TRP-related IDs may be added.

### <<Step 1>>

The UE may use at least two RSs for the RLM-RSs on the basis of active TCI states for PDCCH reception from different TRP-related IDs. The UE may select, in respective TRP-related IDs, the RLM-RSs by using the RLM-RS determination rule of NR Rel. 15 or RS determination method 1.

### <<Step 2>>

After the UE determines at least two RLM-RSs from different TRP-related IDs, the UE may determine remaining RLM-RSs on the basis of one of the following step 2-1 and step 2-2.

### <<Step 2-1>>

The UE may determine the remaining RLM-RSs on the basis of the RLM-RS determination rule of NR Rel. 15 or RS determination method 1.

### <<Step 2-2>>

The UE may determine the remaining RLM-RSs in order starting from two TRPs or different TRP-related IDs. The UE may determine, in respective TRP-related IDs, the RLM-RSs on the basis of the RLM-RS determination rule of NR Rel. 15 or RS determination method 1.

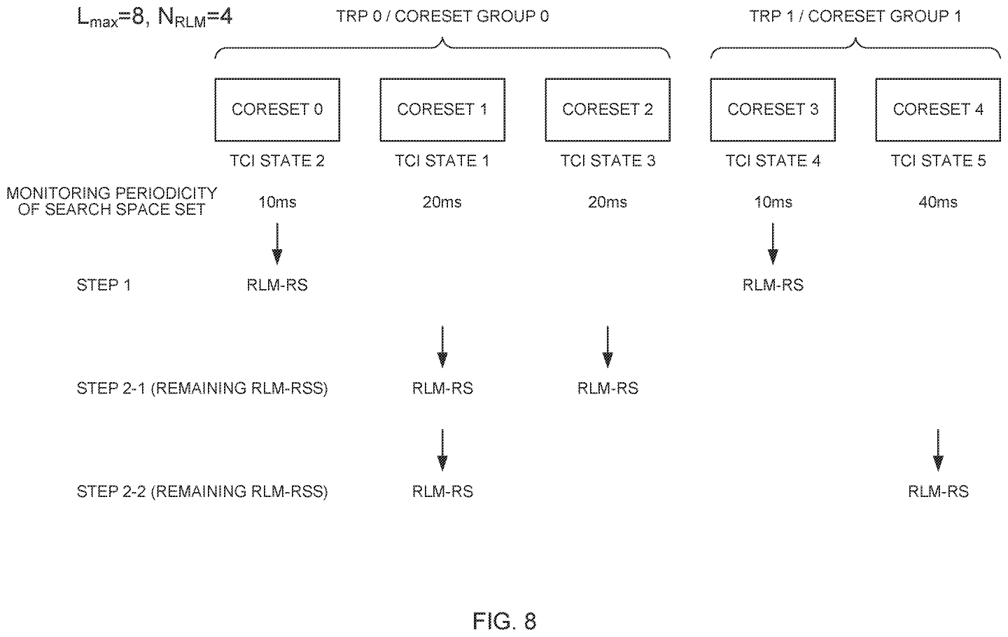

In FIG. 8, a configuration of TRPs, CORESET groups, CORESETs, monitoring periodicities of search space sets, and TCI states is similar to that of FIG. 6.

In this example, Lₘₐₓ=8 and N_{RLM}=4, and the UE uses rule 1-1.

In step 1, the UE determines, on the basis of rule 1-1, the RLM-RSs from respective different CORESET groups. In this example, the UE selects, as the RLM-RSs, TCI state 2 for a PDCCH in CORESET 0 associated with a search space set having the shortest monitoring periodicity 10 ms in CORESET group 0, and selects, as the RLM-RSs, TCI state 4 for a PDCCH in CORESET 3 associated with a search space set having the shortest monitoring periodicity 10 ms in CORESET group 1. With this operation, the UE selects two RLM-RSs out of N_{RLM} (4) RLM-RSs, and selects the remaining two RLM-RSs in step 2.

When using step 2-1, the UE determines the remaining RLM-RSs on the basis of rule 1-1. In this example, the UE selects, as the RLM-RSs, TCI state 3 and TCI state 1 for PDCCHs in CORESETs in order starting from a CORESET having the highest CORESET ID, out of CORESET 1 and CORESET 2 associated with a search space set having the next shortest monitoring periodicity 20 ms in CORESET group 0.

When using step 2-2, the UE determines, on the basis of rule 1-1, the RLM-RSs from respective different CORESET groups. In this example, the UE selects, as the RLM-RSs, TCI state 3 for a PDCCH in a CORESET having the highest CORESET ID, out of CORESET 1 and CORESET 2 associated with a search space set having the second shortest monitoring periodicity 20 ms in CORESET group 0, and selects, as the RLM-RSs, TCI state 5 for a PDCCH in CORESET 4 associated with a search space set having the second shortest monitoring periodicity 40 ms in CORESET group 1.

According to RS determination method 3 above, when the UE needs to monitor PDCCHs from two TRPs, the RLM-RSs include RSs from the two TRPs, and thus RLM for the two TRPs can be certainly performed. For example, in a case of switching two TRPs, radio links with the two TRPs can be maintained.

### <<RS Determination Method 4>>

The UE may determine BFD-RSs (set q₀ of aperiodic CSI-RS resource configuration indices) by using a BFD-RS determination rule based on the RLM-RS determination rule of NR Rel. 15 or RS determination method 1. In this case, the UE may determine, as the BFD-RSs, RSs with TCI states associated with at least one TRP.

The UE may determine, on the basis of the BFD-RS determination rule, up to Y BFD-RSs. Y may be 2, or may be 3 or more.

The BFD-RS determination rule may be one of the following rule 2-1 to rule 2-4.

### <<Rule 2-1>> (Based on Rule 1-1)

The UE may select, in sequence starting from the shortest monitoring periodicity of a search space set, up to Y RSs provided for active TCI states for PDCCH reception in CORESETs associated with search space sets. When more than one CORESET is associated with search space sets having the same monitoring periodicity, the UE may determine a CORESET sequence starting from the highest CORESET index.

### <<Rule 2-2>> (Based on Rule 1-2)

The UE may select, in sequence starting from the shortest monitoring periodicity of a search space set, up to Y RSs provided for active TCI states for PDCCH reception in CORESETs associated with search space sets. When one or more CORESETs are associated with search space sets having the same monitoring periodicity, the UE may determine a CORESET sequence starting from the lowest CORESET index.

### <<Rule 2-3>> (Based on Rule 1-3)

The UE may select, in sequence starting from the longest monitoring periodicity of a search space set, up to Y RSs provided for active TCI states for PDCCH reception in CORESETs associated with search space sets. When more than one CORESET is associated with search space sets having the same monitoring periodicity, the UE may determine a CORESET sequence starting from the highest CORESET index.

### <<Rule 2-4>> (Based on Rule 1-4)

The UE may select, in sequence starting from the longest monitoring periodicity of a search space set, up to Y RSs provided for active TCI states for PDCCH reception in CORESETs associated with search space sets. When more than one CORESET is associated with search space sets having the same monitoring periodicity, the UE may determine a CORESET sequence starting from the lowest CORESET index.

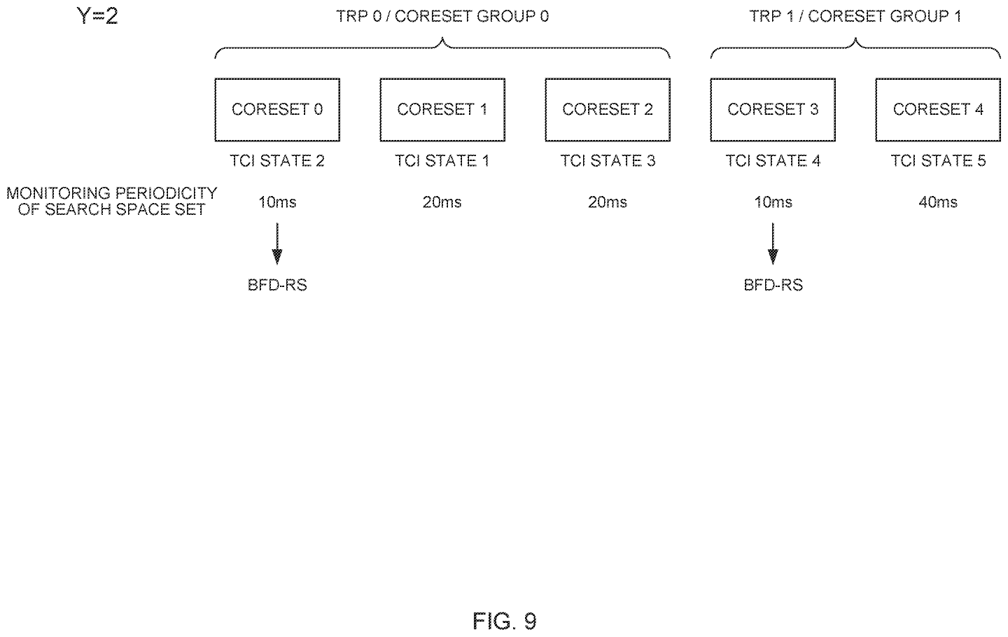

In FIG. 9, a configuration of TRPs, CORESET groups, CORESETs, monitoring periodicities of search space sets, and TCI states is similar to that of FIG. 6.

In this example, Y=2 and the UE uses rule 2-1.

The UE selects, in order of a monitoring periodicity, TCI state 2 and TCI state 4 for PDCCHs in CORESET 0 and CORESET 3 associated with search space sets having the shortest monitoring periodicity 10 ms, out of CORESETs in all CORESET groups. With this operation, the UE determines RSs with selected TCI state 2 and TCI state 3 as two BFD-RSs.

The BFD-RS determination rule may use, for monitoring periodicities and CORESET IDs, the same sequence as that of the RLM-RS determination rule. In this case, reliability of the BFD-RSs can be improved.

The BFD-RS determination rule may use, for monitoring periodicities and CORESET IDs, a sequence different from that of the RLM-RS determination rule. In this case, there is a possibility that a state not detected by the RLM-RSs can be detected by the BFD-RSs.

According to RS determination method 4 above, the UE can determine a BFD-RS even when the BFD-RS is not provided for the UE.

### <<RS Determination Method 5>>

In the RLM-RS determination rule of NR Rel. 15 or the BFD-RS determination rule of RS determination method 4, a limitation that an active TCI state for PDCCH reception in CORESETs having the lowest or highest TRP-related ID is used may be added.

The UE may select, as the BFD-RSs (set q₀), Y RSs provided for active TCI states for PDCCH reception in CORESETs associated with search spaces, out of CORESETs having the lowest or highest TRP-related ID, in sequence starting from the shortest monitoring periodicity of a search space. If more than one CORESET having the same TRP-related ID is associated with search space sets having the same monitoring periodicity, the UE may determine a CORESET sequence starting from the highest or lowest CORESET index having the TRP-related ID.

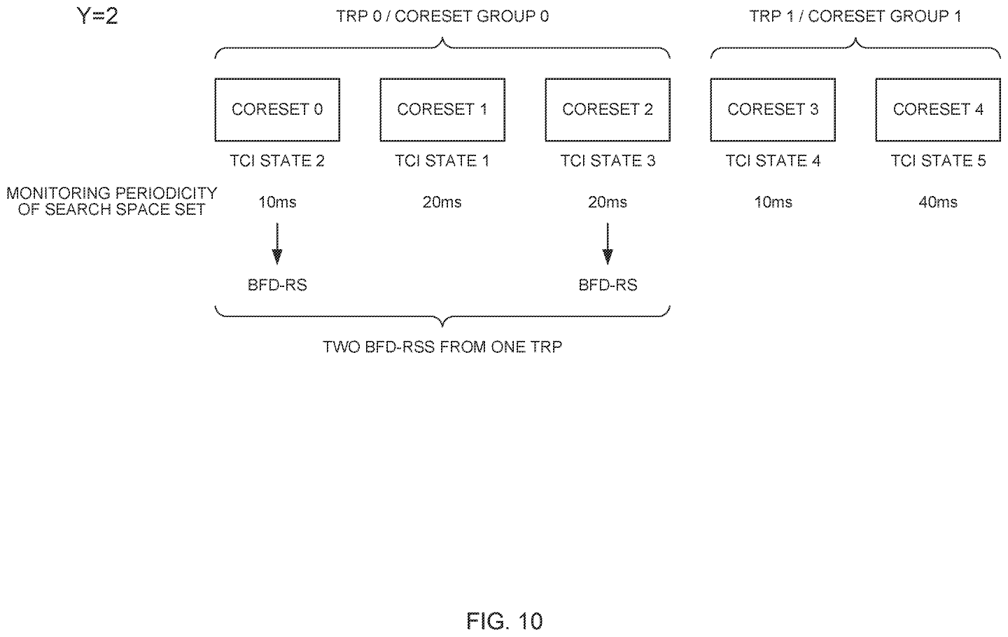

In FIG. 10, a configuration of TRPs, CORESET groups, CORESETs, monitoring periodicities of search space sets, and TCI states is similar to that of FIG. 6.

In this example, Y=2, and the UE uses rule 2-1.

In this example, assume that limitation to the BFD-RS determination rule is that the PDCCH is a PDCCH in a CORESET having the lowest CORESET group ID. In this example, the UE limits the BFD-RSs to active TCI states for PDCCHs in CORESETs in CORESET group 0 (TRP 0).

The UE selects, in order of a monitoring periodicity, TCI state 2 for a PDCCH in CORESET 0 associated with a search space set having the shortest monitoring periodicity 10 ms, out of CORESETs having the lowest CORESET group ID, and selects TCI state 3 for a PDCCH in CORESET 2 having the highest CORESET index, out of two CORESETs associated with a search space set having the second shortest monitoring periodicity 20 ms. With this operation, the UE determines, from CORESET group 0 corresponding to one TRP, RSs with TCI state 2 and TCI state 3 as two BFD-RSs.

According to RS determination method 5, a plurality of BFD-RSs associated with a specific TRP (connected TRP, default TRP) are selected, and thus BFD for the specific TRP can be certainly performed.

### <<RS Determination Method 6>>

In the RLM-RS determination rule of NR Rel. 15 or the BFD-RS determination rule of RS determination method 4, enhancement in which the UE uses, as the BFD-RSs, Y RSs provided for active TCI states for PDCCH reception in CORESETs having two TRP-related IDs may be added. In the RLM-RS determination rule of NR Rel. 15 or the BFD-RS determination rule of RS determination method 4, enhancement in which the UE uses, as the BFD-RSs, two RSs each provided for an active TCI state for PDCCH reception in CORESETs having two TRP-related IDs may be added.

The UE may select, as the BFD-RSs (set q₀), Y RSs provided for active TCI states for PDCCH reception in CORESETs associated with search spaces from respective two CORESETs having different TRP-related IDs, in sequence starting from the shortest monitoring periodicity of a search space. If more than one CORESET having the same TRP-related ID is associated with search space sets having the same monitoring periodicity, the UE may determine a CORESET sequence starting from the highest or lowest CORESET index having the TRP-related ID.

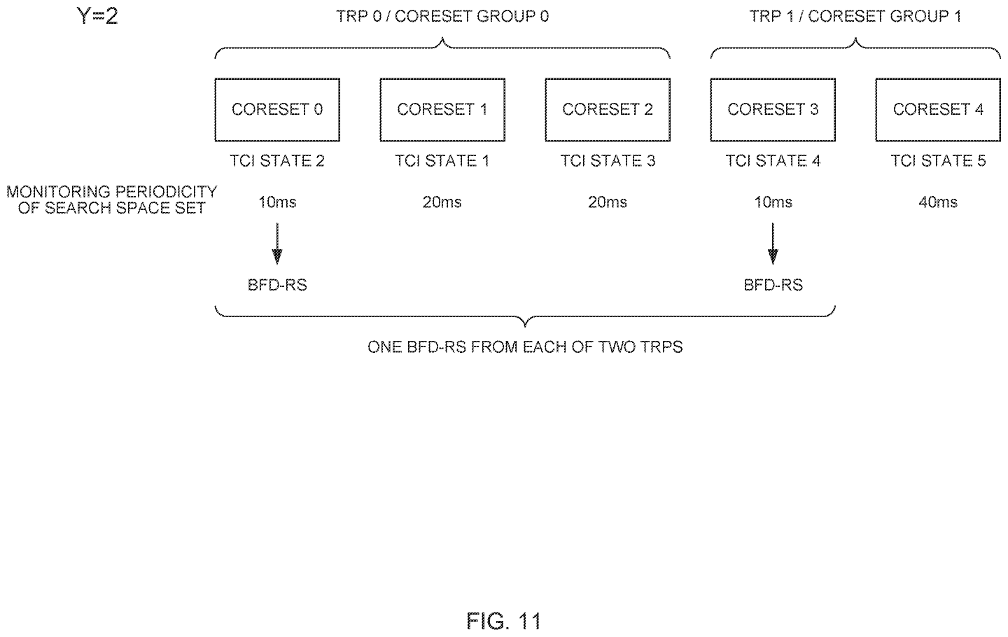

In FIG. 11, a configuration of TRPs, CORESET groups, CORESETs, monitoring periodicities of search space sets, and TCI states is similar to that of FIG. 6.

In this example, Y=2 and the UE uses rule 2-1.

The UE determines, on the basis of rule 2-1, the RLM-RSs from respective different CORESET groups. In this example, the UE selects, as the BFD-RSs, TCI state 2 for a PDCCH in CORESET 0 associated with a search space set having the shortest monitoring periodicity 10 ms in CORESET group 0, and selects, as the BFD-RSs, TCI state 4 for a PDCCH in CORESET 3 associated with a search space set having the shortest monitoring periodicity 10 ms in CORESET group 1. With this operation, the UE determines TCI state 2 and TCI state 4 as the BFD-RSs.

According to RS determination method 6 above, when the UE needs to monitor PDCCHs from two TRPs, the BFD-RSs include RSs from the two TRPs, and thus BFD for the two TRPs can be certainly performed. For example, in a case of switching between two TRPs, beams for the two TRPs can be maintained.

### <<RS Determination Method 7>>

When BFD-RSs are provided for the UE, up to X BFD-RSs (set q₀) may be provided for the UE. When the BFD-RSs are not provided for the UE, the UE may determine up to Y BFD-RSs in accordance with one of RS determination method 4 to RS determination method 6. Y may be X, or may be X+1. X may be 2, or may be 3 or more.

Therefore, the UE can determine an appropriate number of BFD-RSs even when BFD-RSs are not configured.

### <<RS Determination Method 8>>

The UE may report, to a network, UE capability information (UE capability) including information related to at least one of the following:
Whether to support simultaneous reception of plurality of pieces of DCI (multiple DCI, multiple PDCCHs) (for example, whether to allow detection of two or more DCI formats of plurality of PDCCHs in which first symbol is received in same symbol in same slot)
Whether to support simultaneous reception of plurality of pieces of DCI not being in specific QCL relationship (for example, not being QCL type D)
Whether to support NCJT of PDSCH (in other words, simultaneous reception of plurality of PDSCHs (codewords) not being in specific QCL relationship (for example, not being QCL type D))
Whether to support single DCI
Whether to support multiple DCI
Number of pieces of DCI capable of being detected (or decoded) by UE in certain PDCCH monitoring period or same symbol (for example, OFDM symbol)
Number of pieces of DCI capable of being detected (or decoded) by UE in certain PDCCH monitoring period or same symbol (for example, OFDM symbol), the DCI not being in specific QCL relationship (for example, not being QCL type D)
Number of PDSCHs (or codewords) capable of being detected (or decoded) by UE in same symbol (for example, OFDM symbol)
Number of PDSCHs (or codewords) capable of being detected (or decoded) by UE in same symbol (for example, OFDM symbol), the PDSCHs not being in specific QCL relationship (for example, not being QCL type D)
Number or maximum number of RLM-RSs selected by UE in case where RLM-RSs are not provided
Number or maximum number of BFD-RSs selected by UE in case where BFD-RSs are not provided

The UE may assume that at least one of the above-mentioned RS determination methods is employed (or the employment is configured) when at least one of the above-described UE capabilities has been reported. The network may notify the UE that has reported at least one of the above-described UE capabilities of information to enable an operation based on at least one of the above-mentioned RS determination methods.

Note that such an operation may be applied only in a certain frequency range (for example, Frequency Range 2 (FR 2)). Such an operation can reduce complication of the UE.

### <<Another RS Determination Method>>

In each RS determination method above, at least one of the following may be applied.

The UE may assume that the number N_{RLM} of RLM-RSs is not greater than the number of CORESETs.

When N_{RLM} is greater than the number of CORESETs, the UE may determine, by using the number of active TCI states (the number of TCI states activated by a MAC CE) in place of N_{RLM}, RLM-RSs up to the number of active TCI states. It is conceivable that the number of active TCI states is greater than the number of CORESETs.

The UE may assume that the number Y of BFD-RSs is not greater than the number of CORESETs.

When Y is greater than the number of CORESETs, the UE may determine, by using the number of active TCI states in place of Y, BFD-RSs up to the number of active TCI states.

The UE may use an RLM-RS determination rule that differs between a case of using a single TRP and a case of using multiple TRPs.

The UE may use a BFD-RS determination rule that differs between a case of using a single TRP and a case of using multiple TRPs.

The UE may change at least one of the RLM-RS determination rule and the RLM-RS determination rule on the basis of at least one of RRC signaling, a MAC CE, and DCI. For example, at least one of the RLM-RS determination rule and the BFD-RS determination rule may differ between a case where at least one condition of a case where DCI to schedule a PDSCH is received, a case where PDSCHs from a plurality of TRPs are simultaneously received, or a case where the UE has a TCI state for each TRP is satisfied and a case where the condition is not satisfied.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

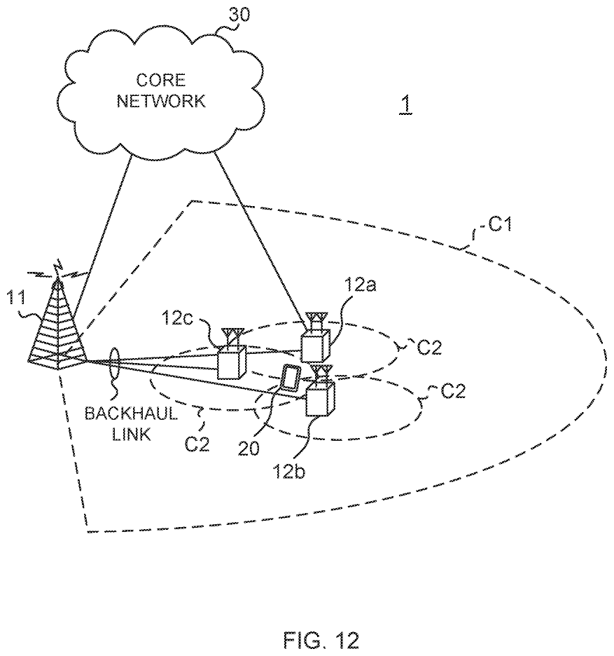

FIG. 12 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).” (Base Station)

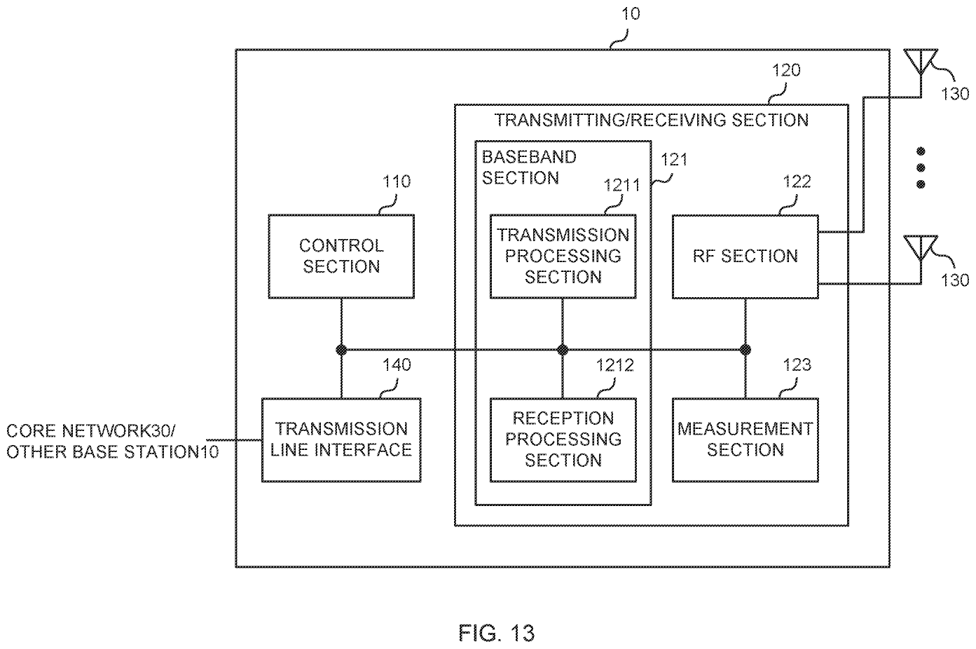

FIG. 13 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a medium access control-control element (MAC CE) to activate two transmission configuration indication (TCI) states for one codepoint of a field in downlink control information. The control section 110 may determine one or more reference signals in a case where a reference signal for beam failure detection (BFD) is not configured, the one or more reference signals being used for BFD.

### (User Terminal)

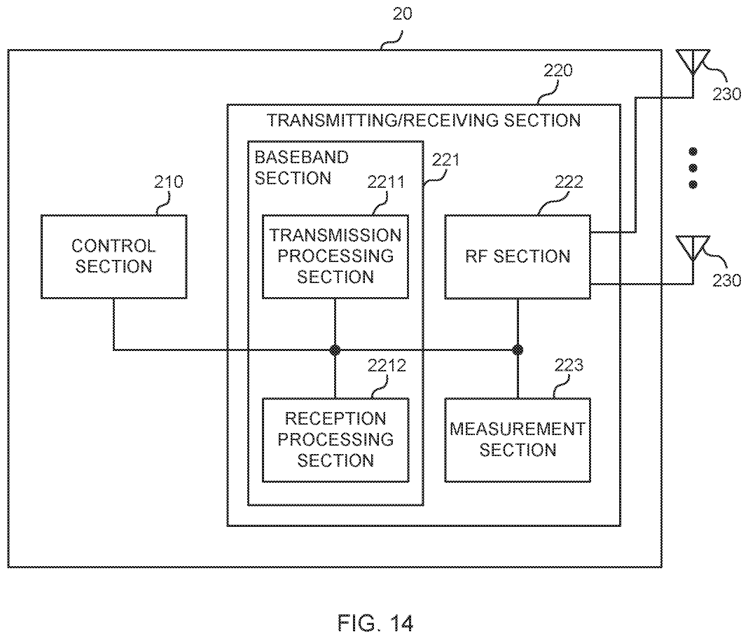

FIG. 14 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220, the transmitting/receiving antennas 230, and the communication path interface 240.

The transmitting/receiving section 220 may receive a medium access control-control element (MAC CE, for example, a MAC CE for enhanced TCI state activation/deactivation for a UE-specific PDSCH) to activate two transmission configuration indication (TCI) states for one codepoint of a field in downlink control information. The control section 210 may determine one or more reference signals (for example, BFD RSs or implicit BFD RSs) in a case where a reference signal for beam failure detection (BFD) is not configured, the one or more reference signals being used for BFD.

The one or more reference signals may be two sets of reference signals. The two sets may be associated with the two TCI states, respectively.

The two TCI states may be associated with two control resource sets, respectively.

One of the two sets may be a non-serving cell reference signal.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

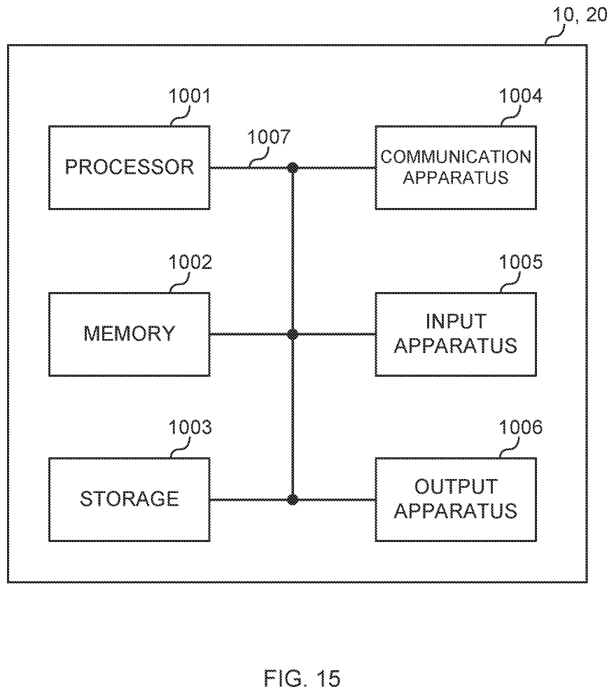

For example, a base station, a user terminal, and so on according to one embodiment of the present disclosure may function as a computer that executes the processes of the radio communication method of the present disclosure. FIG. 15 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

This application is based on Japanese Patent Application No. 2020-186141 filed on Nov. 6, 2020. The entire contents of the application are herein incorporated.

1. A terminal comprising:
a receiving section that receives a medium access control-control element (MAC CE) to activate two transmission configuration indication (TCI) states for one codepoint of a field in downlink control information; and
a control section that determines one or more reference signals in a case where a reference signal for beam failure detection (BFD) is not configured, the one or more reference signals being used for BFD.

2. The terminal according to claim 1, wherein the one or more reference signals are two sets of reference signals, the two sets being associated with the two TCI states, respectively.

3. The terminal according to claim 2, wherein the two TCI states are associated with two control resource sets, respectively.

4. The terminal according to claim 2, wherein one of the two sets is a non-serving cell reference signal.

5. A radio communication method for a terminal, the radio communication method comprising:
receiving a medium access control-control element (MAC CE) to activate two transmission configuration indication (TCI) states for one codepoint of a field in downlink control information; and
determining one or more reference signals in a case where a reference signal for beam failure detection (BFD) is not configured, the one or more reference signals being used for BFD.

6. A base station comprising:
a transmitting section that transmits a medium access control-control element (MAC CE) to activate two transmission configuration indication (TCI) states for one codepoint of a field in downlink control information; and
a control section that determines one or more reference signals in a case where a reference signal for beam failure detection (BFD) is not configured, the one or more reference signals being used for BFD.

7. The terminal of claim 3, wherein one of the two sets is a non-serving cell reference signal.
